(19) United States
(12) Patent Application Publication
(10) Pub. No.: US 2022/0030374 A1
(43) Pub. Date: Jan. 27, 2022

(54) Method of Processing Audio Signal and Audio Signal Processing Apparatus

(71) Applicant: Yamaha Corporation, Hamamatsu-shi (JP)

(72) Inventors: Akihiko Suyama, Hamamatsu-shi (JP); Tatsuya Fukuyama, Hamamatsu-shi (JP); Ryotaro Aoki, Hamamatsu-shi (JP)

(21) Appl. No.: 17/448,466

(22) Filed: Sep. 22, 2021

Related U.S. Application Data
(63) Continuation of application No. PCT/JP2020/008617, filed on Mar. 2, 2020.

(30) Foreign Application Priority Data
Mar. 25, 2019 (JP) 2019-055841

(51) Int. Cl. H04S 7/00; G06F 3/03

(52) U.S. Cl. CPC H04S 7/302; G06F 3/0312; H04S 2400/13; H04S 2420/01; H04S 2400/11

(57) ABSTRACT

A method of processing an audio signal includes inputting an audio signal, obtaining position information of a sound source of the audio signal, receiving an input of movement information, moving a position of the sound source around a predetermined axis, based on the movement information, changing a sound image localization position of the sound source, and performing localization processing on the audio signal so as to localize a sound image of the sound source at a changed sound image localization position.

### CROSS REFERENCE TO RELATED APPLICATIONS

The present application is a continuation application of International Patent Application No. PCT/JP2020/008617, filed on Mar. 2, 2020, which claims priority to Japanese Patent Application No. 2019-055841, filed on Mar. 25, 2019, the entire contents of each of which are incorporated herein by reference.

### BACKGROUND

### Technical Field

An embodiment of the present disclosure relates to a method of processing an audio signal.

### Background Information

Japanese Unexamined Patent Application Publication No. 2014-103456 discloses an audio amplifier that localizes a virtual sound source at a position that a user shows using a smartphone. The smartphone disclosed in Japanese Unexamined Patent Application Publication No. 2014-103456 detects information on a posture of the smartphone. The smartphone converts the information on the posture into position information of a speaker in a coordinate space having a listening point as an origin point, and specifies a direction of a sound source.

Determining a position of a sound source more intuitively than in the past is desired.

### SUMMARY

In view of the foregoing, an embodiment of the present disclosure is directed to providing a method of processing an audio signal that is able to determine a position of a sound source more intuitively than in the past.

A method of processing an audio signal according to an embodiment of the present disclosure inputs an audio signal, obtains position information of a sound source of the audio signal, receives an input of movement information, moves a position of the sound source around a predetermined axis, based on the movement information, changes a sound image localization position of the sound source, and performs localization processing on the audio signal so as to localize a sound image of the sound source at a changed sound image localization position.

According to an embodiment of the present disclosure, a position of a sound source is moved by a movement operation, so that the position of the sound source is able to be determined more intuitively than in the past.

### BRIEF DESCRIPTION OF THE DRAWINGS

FIG. 1 is a block diagram showing a configuration of an audio signal processing system.

FIG. 2 is a perspective view schematically showing a room L1 being a listening environment.

FIG. 3 is a block diagram showing a configuration of an audio signal processing apparatus 1.

FIG. 4 is a block diagram showing a functional configuration of a CPU 17.

FIG. 5 is a flow chart showing an operation of the CPU 17.

FIG. 6 is a perspective view schematically showing a relationship between the room L1 and rotation information.

FIG. 7 is a perspective view schematically showing movement of a sound source when a user rotates a trackball 3 about a Y axis 90 degrees counterclockwise.

FIG. 8 is a block diagram showing a configuration of the audio signal processing system in a case in which information of an X coordinate, a Y coordinate, pageup, and pagedown is outputted.

FIG. 9 is a flow chart showing an operation of the CPU 17 in a calibration mode.

FIG. 10 is a perspective view schematically showing a relationship between the room L1 and a position of the sound source.

FIG. 11 is a perspective view schematically showing a relationship between the room L1 and a position of the sound source.

FIG. 12 is a perspective view schematically showing a relationship between the room L1 and a position of the sound source.

FIG. 13A and FIG. 13B are perspective views schematically showing a relationship between the room L1 and a position of the sound source.

FIG. 14A and FIG. 14B are perspective views schematically showing a relationship between the room L1 and a position of the sound source.

FIG. 15 is a block diagram showing a configuration of the audio signal processing system.

FIG. 16 is a block diagram showing a configuration of the audio signal processing system.

FIG. 17A and FIG. 17B are perspective views schematically showing a relationship between the room L1 and a position of the sound source.

FIG. 18A and FIG. 18B are perspective views schematically showing a relationship between the room L1 and a position of the sound source.

FIG. 19 is a perspective view showing an operation reception device 30.

FIG. 20 is a perspective view showing a modification of an operation reception device 31.

FIG. 21 is a flow chart showing an operation of a sound source position controller 172.

FIG. 22 is a view showing a relationship between an amount of movement of a stick controller and a maximum value.

### DETAILED DESCRIPTION

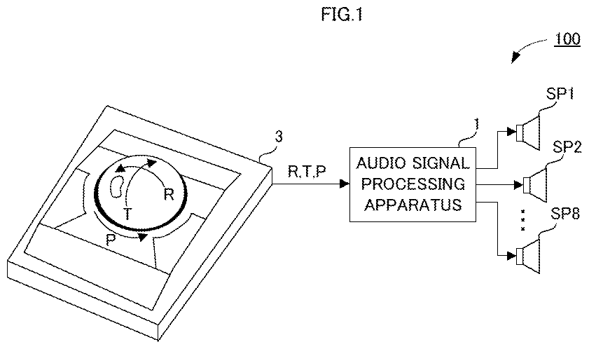

FIG. 1 is a block diagram showing a configuration of an audio signal processing system. An audio signal processing system 100 includes an audio signal processing apparatus 1, a trackball 3, and a plurality of speakers (eight speakers in this example) SP1 to SP8.

The audio signal processing apparatus 1 may be a personal computer, a set top box, an audio receiver, or a powered speaker, for example. The audio signal processing apparatus 1 decodes content data and extracts an audio signal. The audio signal processing apparatus 1 may obtain the content data, for example, from an external reproduction device, a network, or a storage medium. Alternatively, the audio signal processing apparatus 1 may obtain a digital audio signal or an analog audio signal. It is to be noted that, in the present embodiment, unless otherwise described, an audio signal refers to a digital audio signal.

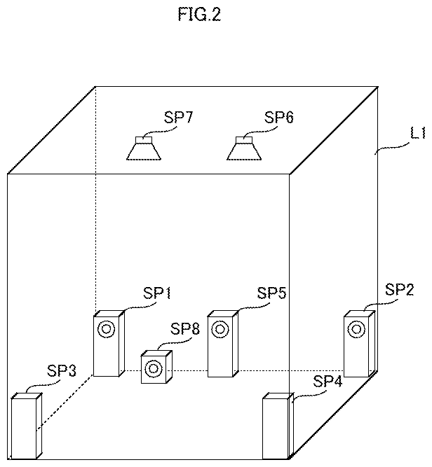

As shown in FIG. 2, the speakers SP1 to SP8 are arranged in a room L1. In this example, the room has a rectangular parallelepiped shape. For example, the speaker SP1, the speaker SP2, the speaker SP3, and the speaker SP4 are arranged on the floor in the four corners of the room L1. The speaker SP5 is arranged on one of sides (the front side in this example) of the room L1. The speaker SP6 and the speaker SP7 are arranged on a ceiling of the room L1. The speaker SP8 is a subwoofer and is arranged near the speaker SP5, for example.

The audio signal processing apparatus 1 performs sound image localization processing to localize a sound image of a sound source at a predetermined position by distributing an audio signal to the speakers with a predetermined gain and a predetermined delay time.

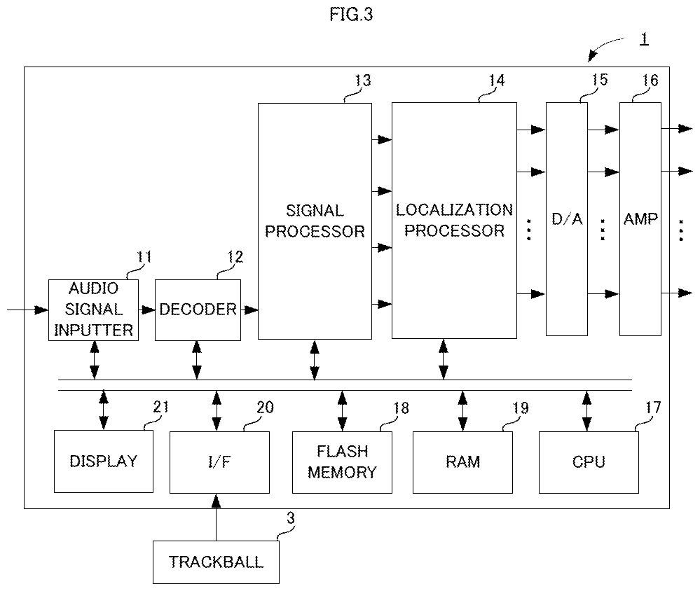

As shown in FIG. 3, the audio signal processing apparatus 1 includes an audio signal inputter 11, a decoder 12, a signal processor 13, a localization processor 14, a D/A converter 15, an amplifier (AMP) 16, a CPU 17, a flash memory 18, a RAM 19, an interface (I/F) 20, and a display 21.

The CPU 17 reads an operating program (firmware) stored in the flash memory 18 to the RAM 19 and collectively controls the audio signal processing apparatus 1.

The audio signal inputter 11 is a communication interface such as an interface of an HDMI (registered trademark) or a network interface, for example. The audio signal inputter 11 receives an input of content data and outputs the content data to the decoder 12. Alternatively, the audio signal inputter 11 may receive an input of a digital audio signal or an analog audio signal.

The decoder 12 includes a DSP, for example. The decoder decodes content data and extracts an audio signal. The decoder 12, in a case in which inputted content data is supported in an object-based system, extracts object information. The object-based system stores a plurality of objects (sound sources) contained in content as respective independent audio signals. The decoder 12 inputs an audio signal of each of the plurality of sound sources into the signal processor 13. In addition, the object information includes position information of each sound source and information such as a level. The decoder 12 inputs the position information and level information of a sound source into the CPU 17.

The signal processor 13 includes a DSP, for example. The signal processor 13 performs predetermined signal processing such as delay, reverb, or equalizer, on the audio signal of each sound source. The signal processor 13 inputs the audio signal of each sound source on which the signal processing has been performed, to the localization processor 14.

The localization processor 14 includes a DSP, for example. The localization processor 14 performs sound image localization processing according to instructions of the CPU 17. The localization processor 14 distributes the audio signal of each sound source with a predetermined gain to the speakers SP1 to SP8 so as to localize a sound image at a position corresponding to the position information of each sound source specified by the CPU 17. The localization processor 14 inputs the audio signal to each speaker SP1 to SP8, to the D/A converter 15.

The D/A converter 15 converts each audio signal into an analog signal. The AMP 16 amplifies each analog audio signal and inputs the analog audio signal to the speakers SP1 to SP8.

It is to be noted that the decoder 12, the signal processor 13, and the localization processor 14 may be implemented by hardware including respective individual DSPs or may be implemented by software including one DSP.

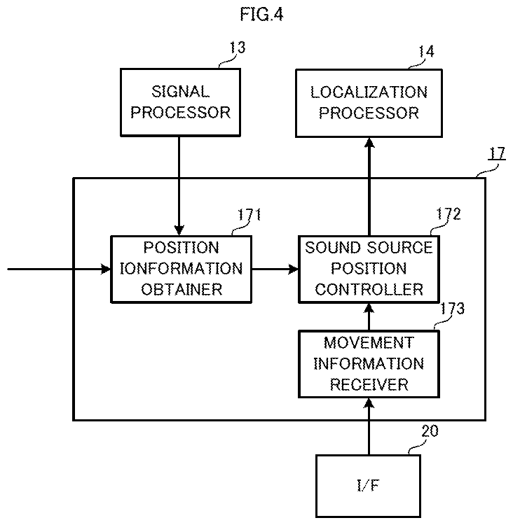

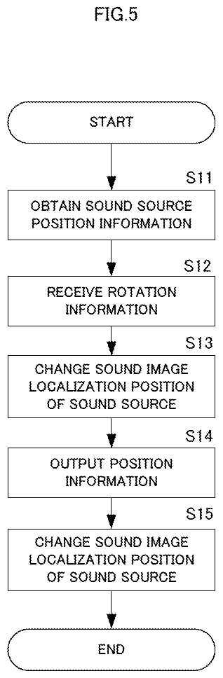

FIG. 4 is a block diagram showing a functional configuration of the CPU 17. The CPU 17, as a function, includes a position information obtainer 171, a sound source position controller 172, and a movement information receiver 173. FIG. 5 is a flow chart showing an operation of the CPU 17. Such a function is implemented by a program of the CPU 17.

The position information obtainer 171 obtains position information of a sound source from the decoder 12 (S11). The position information obtainer 171, in a case of an audio signal supported in the object-based system, receives object information and obtains the position information included in the object information. In a case in which inputted content data is supported in a channel-based system, the signal processor 13 analyzes the audio signal and extracts the position information of the sound source. In such a case, the position information obtainer 171 obtains the position information of the sound source from the signal processor 13.

The signal processor 13 calculates a level of the audio signal of each channel, and a cross correlation between channels, for example. The signal processor 13 estimates a position of the sound source, based on the level of the audio signal of each channel and the cross correlation between the channels. For example, in a case in which a correlation value of an L (Left) channel and a R (Right) channel is high and the level of the L channel and the level of the R channels are high (exceed a predetermined threshold), the sound source is estimated to be present between the L channel and the R channel. The signal processor 13 estimates a position of the sound source, based on the level of the L channel and the level of the R channel. The signal processor 13, when the ratio of the level of the L channel and the level of the R channel is 1:1, estimates the position of the sound source at the midpoint of the L channel and the R channel, for example. As the number of channels is increased, the position of the sound source is able to be estimated more accurately. The signal processor 13 is able to almost uniquely specify the position of the sound source by calculating a correlation value between a large number of channels.

The signal processor 13 performs such analysis processing on the audio signal of each channel and generates the position information of the sound source. The position information obtainer 171 obtains the position information of the sound source generated by the signal processor 13. In addition, the position information obtainer 171 may obtain both the position information decoded by the decoder 12 and the position information extracted by the signal processor 13. In such a case, the sound source position controller 172 determines an intermediate position (an average position) of the both pieces of position information, as the position information of the sound source. In addition, the position information obtainer 171 may change the position information decoded by the decoder 12 or the position information extracted by the signal processor 13, by receiving an input from a user. Further, the sound source position controller 172 may receive a setting of an initial position of a sound source, from a user. In such a case, the position information obtainer 171 obtains the position information of the sound source by receiving a coordinate input from a user.

The sound source position controller 172 obtains the position information of the sound source from the position information obtainer 171. The sound source position controller 172 receives rotation information from the movement information receiver 173 (S12). The sound source position controller 172, based on the rotation information, rotates the position of the sound source about a predetermined axis, and changes the sound image localization position of the sound source in the localization processor 14 (S13).

The movement information receiver 173 receives the rotation information from the trackball 3 through the I/F 20. The I/F 20 is a USB interface, for example. The trackball 3 outputs information of roll (R), tilt (T), and pitch (P) as rotation information of three axes (three dimensions).

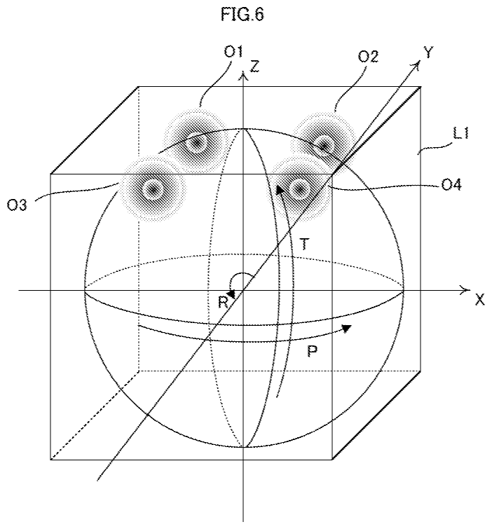

FIG. 6 is a perspective view schematically showing a relationship between the room L1 and the rotation information. The trackball 3 outputs a rotation operation to rotate about front and rear (Y) positions of a user as roll (R) information. The trackball 3 outputs a rotation operation to rotate about left and right (X) positions of a user as tilt (T) information. The trackball 3 outputs a rotation operation to rotate about up and down (Z) positions of a user as pitch (R) information.

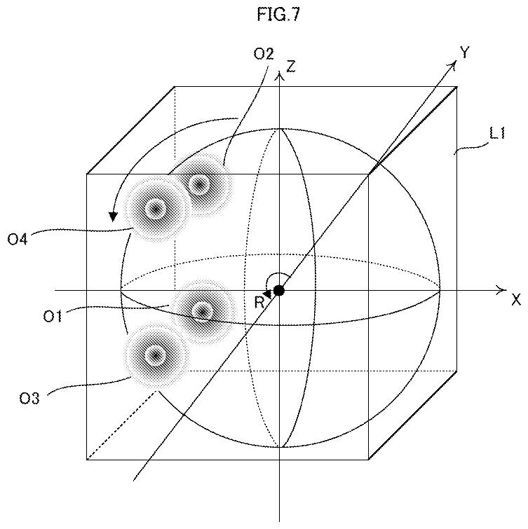

FIG. 7 is a perspective view schematically showing movement of a sound source when a user rotates the trackball 3 about a Y axis 90 degrees counterclockwise. In a state of FIG. 6, the localization processor 14, near the ceiling in the room, localizes a sound source O1 at the left front, a sound source O2 at the right front, a sound source O3 at the left rear, and a sound source O4 at the right rear. When a user rotates the trackball 3 about the Y axis 90 degrees counterclockwise, the trackball 3 outputs R information of +90 degrees. The movement information receiver 173 receives the R information of +90 degrees. The sound source position controller 172 rotates the position information of the sound source obtained from the position information obtainer 171 about the Y axis 90 degrees counterclockwise, and changes the position of the sound source.

The sound source position controller 172, in a case of managing the position of the sound source by orthogonal coordinates (X, Y, Z coordinates), calculates orthogonal coordinates after rotation, based on received rotation information. For example, the orthogonal coordinates (X, Y, Z) being (1, 0, 0), when being rotated about the Y axis 90 degrees counterclockwise, are converted into (0, 0, 1). Various technologies such as Quaternion are able to be used as a coordinate conversion method.

The sound source position controller 172 outputs changed position information of the sound source to the localization processor 14 (S14). The localization processor 14 performs localization processing, based on the changed position information of the sound source (S15).

As a result, when a user rotates the trackball 3, the position of the sound source also rotates according to such a rotation operation. According to the present embodiment, a position of a sound source is rotated by a rotation operation from a user, so that the position of the sound source is able to be determined more intuitively than in the past. In addition, the user, by simply rotating the trackball 3, can collectively move the plurality of sound sources at a time.

It is to be noted that the present embodiment shows an example in which an input of three-dimensional rotation information is received through the trackball 3. However, the audio signal processing apparatus 1 may receive rotation information (only pan information, for example) in at least one axis, and may rotate the position of a sound source on a two-dimensional plane. The trackball 3 may output only two-dimensional rotation information. In addition, the trackball 3, as with an operation on a mouse of a normal personal computer, may simply output information of an X coordinate corresponding to an amount of rotation in a case of receiving a rotation operation to rotate about the front and rear (Y) positions of a user, and may simply output information of a Y coordinate corresponding to the amount of rotation in a case of receiving a rotation operation to rotate about the left and right (X) positions of a user. Further, the audio signal processing apparatus 1 may move the position of a sound source on one dimension (a straight line).

In addition, the present embodiment shows an example in which the positions of four sound sources are rotated, as an example. However, the audio signal processing apparatus 1 may simply rotate a position of at least one sound source. In addition, the movement information receiver 173 may receive an input to specify a sound source to be rotated. For example, in a case in which the movement information receiver 173 receives the sound source O1 as a candidate to be rotated, the sound source position controller 172 rotates only the sound source position of the sound source O1 and changes the sound image localization position. Further, the present embodiment shows an example in which one trackball 3 is used. However, the audio signal processing system 100 may include a plurality of trackballs 3. In such a case, the audio signal processing apparatus 1 associates each of the plurality of trackballs 3 with a sound source.

It is to be noted that the movement information receiver 173, by grouping the plurality of sound sources as one group, may receive a specified input of whether or not the group is to be rotated for each group.

In addition, the audio signal processing apparatus 1 may further include a display processor that displays the position of a sound source, on the display 21. The display processor is implemented by the function of the CPU 17, for example. The display processor displays the position of a sound source as shown in FIG. 6 and FIG. 7, for example, on the display 21. As a result, a user can grasp the current localization position of the sound source. The user also can easily perform a specified input of a sound source to be rotated, by referring to the display 21.

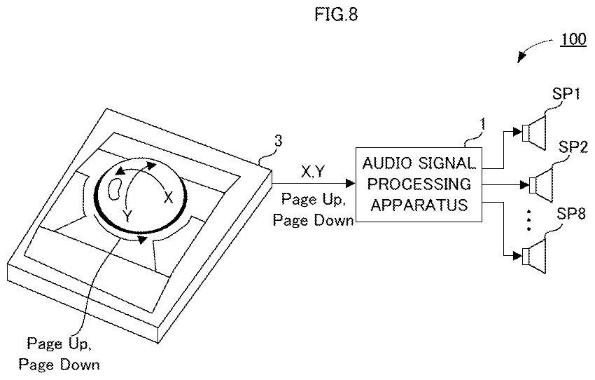

In addition, the trackball 3, as shown in FIG. 8, as with the operation on a mouse of a personal computer, may output information of an X coordinate, a Y coordinate, pageup, and pagedown. In such a case, the sound source position controller 172 converts the information of an X coordinate, a Y coordinate, pageup, and pagedown into rotation information, and changes the sound image localization position of a sound source.

In such a case, the trackball 3 outputs the information of an X coordinate corresponding to the amount of rotation in a case of receiving a rotation operation to rotate about the front and rear (Y) positions of a user. The trackball 3 outputs the information of a Y coordinate corresponding to the amount of rotation in a case of receiving a rotation operation to rotate about the left and right (X) positions of a user. The trackball 3 outputs the information of pageup or pagedown, as with a scroll wheel of a mouse, in a case of receiving a rotation operation to rotate about the up and down (Z) positions of a user. It is to be noted that the trackball 3 may output only the information of an X coordinate and a Y coordinate according to the rotation operation. In such a case, the trackball 3 outputs the information of pageup and pagedown according to an operation on a pageup button and a pagedown button. Alternatively, the trackball 3 outputs the information of pageup and pagedown according to the amount of rotation with respect to a physical controller on a ring.

The sound source position controller 172 previously associates the information of an X coordinate, a Y coordinate, pageup, and pagedown that is outputted by the trackball 3 with rotation information around each axis, and stores such association in the flash memory 18 or the RAM 19. The sound source position controller 172, as a calibration mode, for example, previously associates an operation on the trackball 3 from a user with rotation information.

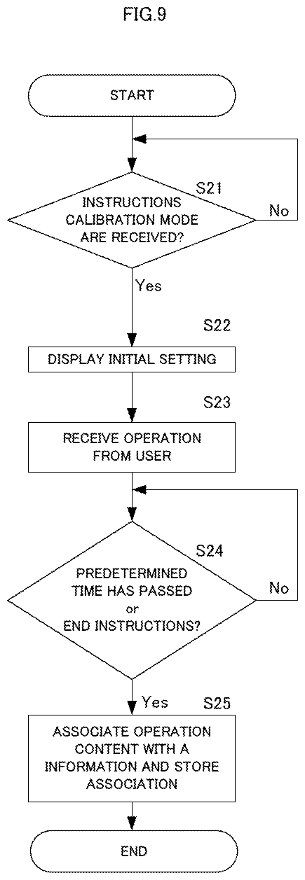

FIG. 9 is a flow chart showing an operation of the CPU 17 in the calibration mode. The CPU 17 determines whether or not instructions in the calibration mode are received from a user (S21). The instructions in the calibration mode are received, for example, when the user presses a not-shown switch or the like that is provided in the audio signal processing apparatus 1.

In a case in which the instructions in the calibration mode are received, the CPU 17 displays “initial setting” or a similar indication on the display 21, for example (S22), and displays a guide to an operation to rotate the trackball 3 about front and rear (Y) positions 90 degrees counterclockwise. A user rotates the trackball 3 counterclockwise 90 degrees, according to a displayed guide. As a result, the movement information receiver 173 receives the information (the information of an X coordinate) corresponding to the rotation operation (S23).

The CPU 17 determines whether or not a predetermined time has passed or end instructions in the calibration mode have been received from a user (S24). In a case in which a predetermined time has passed or end instructions in the calibration mode have been received from a user, the sound source position controller 172 associates a numerical value (X=50, for example) of the X coordinate that has been outputted from the trackball 3 with the roll (R information) of +90 degrees, and stores such association in the flash memory 18 or the RAM 19 (S25). The sound source position controller 172 performs a similar operation with respect to tilt (T information) and pan (P information). In other words, the sound source position controller 172 associates a numerical value of the Y coordinate that has been outputted from the trackball 3 with the tilt (the T information) of +90 degrees, and stores such association in the flash memory 18 or the RAM 19. In addition, the sound source position controller 172 associates a numerical value of the pageup and pagedown that has been outputted from the trackball 3 with the pan (the P information) of +90 degrees, and stores such association in the flash memory 18 or the RAM 19.

It is to be noted that the sound source position controller 172, in a case of receiving a value of pageup (a positive value) when the trackball 3 is rotated clockwise around the Z axis, associates the positive value of the information of pageup with a negative value of pan (P information). In other words, the sound source position controller 172 causes a direction of rotation of the trackball 3 to match a direction of rotation of pan (P information). In addition, the sound source position controller 172, in a case of receiving a negative value as a Y coordinate when the trackball 3 is rotated forward about to the X axis, associates the negative value with a positive value of tilt (T information). In other words, the sound source position controller 172 causes the direction of rotation of the trackball 3 to match a direction of rotation of tilt (T information). However, the sound source position controller 172 may reverse the direction of rotation of the trackball 3 and the rotation information of each axis.

The sound source position controller 172, after ending the calibration mode, converts the information of the X coordinate, the Y coordinate, the pageup, and the pagedown that have been received from the trackball 3 into rotation information, and changes the sound image localization position of the sound source. For example, the sound source position controller 172 converts the information into roll (R information) of +90 degrees in a case in which the numerical value of the X coordinate outputted from the trackball 3 is X=50.

It is to be noted that the CPU 17 may receive only any one of the operations of an X coordinate, a Y coordinates, pageup, and pagedown, and may associate a received operation with rotation information. For example, the CPU 17 may perform only a guide to rotate the trackball 3 counterclockwise 90 degrees, and may receive only the numerical value of an X coordinate, and may associate the value with the rotation information. The rotations of other axes are associated at the same rate as the numerical value of the X coordinate.

It is to be noted that the rotation angle of the trackball 3 and the rotation angle of the sound source do not have to be matched. The sound source position controller 172, in the calibration mode, for example, by associating 90-degree rotation of the trackball 3 with 180-degree rotation of the sound source, is able to rotate the sound source 180 degrees when the trackball 3 is rotated 90 degrees. In such a case, a user can greatly move the sound source by a small rotation operation. In addition, the sound source position controller 172 may greatly move the sound source only by a rotation operation with respect to a specific axis, and may cause the rotation angle of the trackball 3 to match the rotation angle of the sound source by a rotation operation with respect to other axes.

Alternatively, the sound source position controller 172, after receiving rotation information, may change the sound image localization position of a sound source so as to perform inertia movement, by gradually reducing the amount of rotation while continuously rotating a sound source.

In addition, the sound source position controller 172 in the calibration mode, may receive a plurality of times of operations and further improve accuracy by associating an average value of each coordinate with rotation information.

As described above, the sound source position controller 172, as with the operation on a mouse of a personal computer, is able to change the sound image localization position of a sound source according to a rotation operation from a user, even when a device that outputs the information of an X coordinate, a Y coordinate, pageup, and pagedown is connected.

It is to be noted that the trackball 3 may switch a rotation operation mode to output rotation information of three axes and a mouse mode to output information of an X coordinate, a Y coordinate, pageup, and pagedown, as with a normal mouse. For example, the trackball 3 includes a mode changeover switch (not shown) at a portion of a housing. A user, when operating the mode changeover switch, switches the rotation operation mode and the mouse mode. As a result, the user can use the mouse mode in operating a personal computer, and use the rotation operation mode in controlling a position of a sound source as with the present embodiment.

While the present embodiment shows the trackball 3 as a device that receives an operation from a user, various devices are also able to be used as a rotation operation reception device. For example, the sound source position controller 172 may receive a value of a gyro sensor mounted on a smartphone, and may change the sound image localization position of a sound source according to the value of the gyro sensor. In addition, the sound source position controller 172 may change the sound image localization position of a sound source according to a value (a value of a rotary encoder) of a rotation operation of a rotation knob. Moreover, the sound source position controller 172 may change the sound image localization position of a sound source according to an operation on a keyboard for key input. For example, the sound source position controller 172 may rotate the sound image localization position of a sound source 15 degrees every time a user presses a cursor key once.

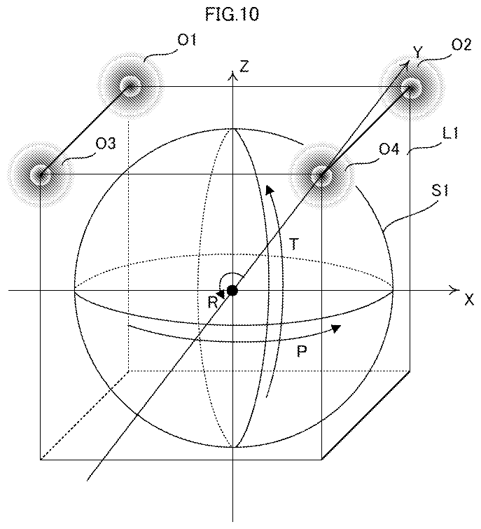

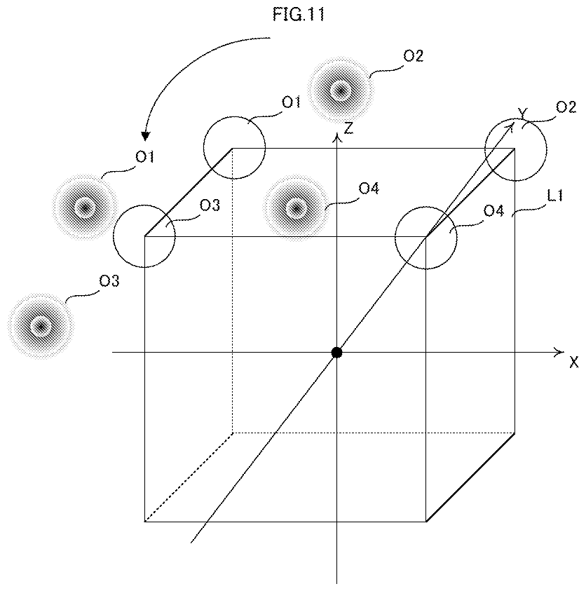

The above-described embodiment shows an example in which all the sound sources are localized inside the room L1. However, as shown in FIG. 10, for example, in a case in which the sound sources are localized at an end of the room L1 and each sound source is rotated, the sound sources, as shown in FIG. 11, are localized outside the room L1. A sound image is localized outside the room L1, which may give an uncomfortable feeling to a user. In addition, a value (−1.000 to +1.000, for example) of a coordinate that the sound source position controller 172 manages may be exceeded.

Then, the sound source position controller 172 may arrange a position of a sound source on a predetermined spherical surface and may rotate the position of a sound source along the spherical surface.

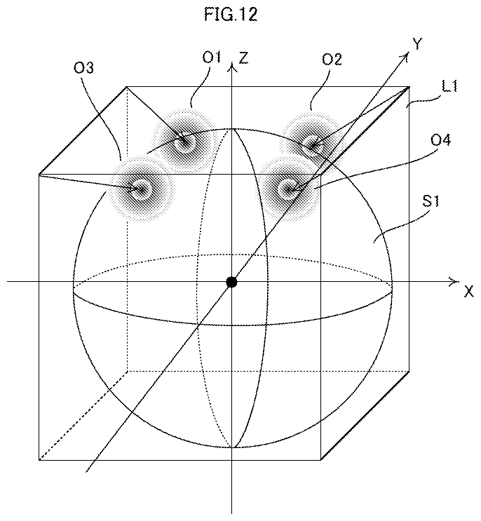

For example, as shown in FIG. 12, the sound source position controller 172, near the ceiling in the room, arranges each of a sound source O1 at the left front, a sound source O2 at the right front, a sound source O3 at the left rear, and a sound source O4 at the right rear, on a spherical surface S1. The spherical surface S1 has a diameter corresponding to a distance between the nearest wall surfaces. In this example, the shape of the room L1 is a cube and the distance from the center position of the room to a partition wall surface is assumed to be 1. Accordingly, a radius of the spherical surface S1 is set as 1. The sound source position controller 172 brings the position of each sound source closer to the center of the room. For example, the sound source position controller 172, in a case in which orthogonal coordinates (X, Y, Z) of the sound source O2 are (1.000, 1.000, 1.000), changes the position of the sound source O2 into a position of (0.577, 0.577, 0.577). Subsequently, the sound source position controller 172, as shown in FIG. 7, based on rotation information, rotates the position of the sound source about a predetermined axis.

The sound source position controller 172 may arrange the position of each sound source away from the center after rotation, and then may rearrange the position at a position on a wall surface of the room L1. Alternatively, the sound source position controller 172 may previously rotate the position of the sound source and then bring the position of the sound source closer to the center of the room, and may rearrange the position at a position on a wall surface. As a result, each sound source is localized at a position on a wall surface of the room L1 or inside the room L1.

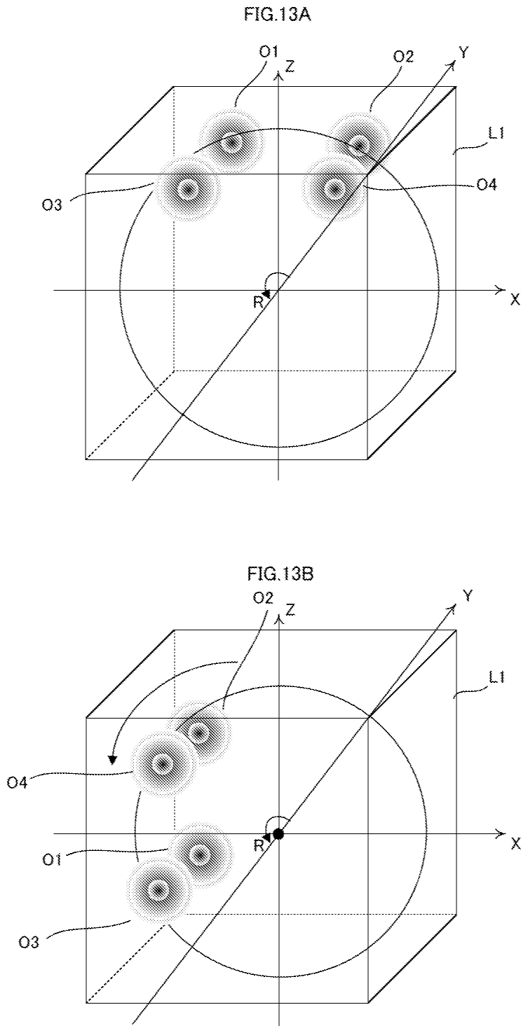

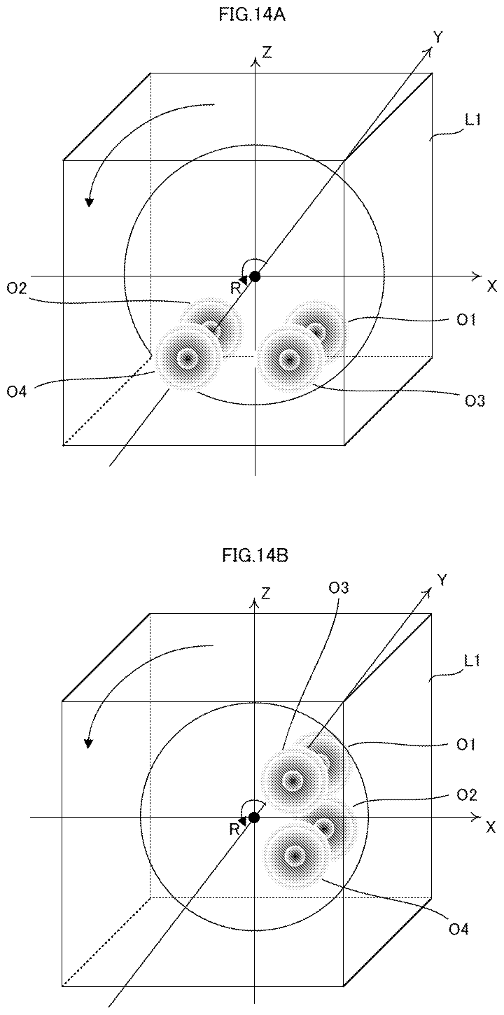

In addition, the sound source position controller 172, as shown in FIG. 13A, FIG. 13B, FIG. 14A, and FIG. 14B, may reduce a size of the spherical surface as the amount of rotation of the position of the sound source is increased. As a result, a user simply performs a rotation operation, which makes it possible to achieve an effect to automatically bring the position of a sound source to the center. Moreover, the sound source position controller 172 may receive an operation to change the size of the spherical surface. For example, in a case in which a user performs a rotation operation about the up and down (Z) positions of the trackball 3 as an axis, the sound source position controller 172 may change the size of the spherical surface according to the rotation operation.

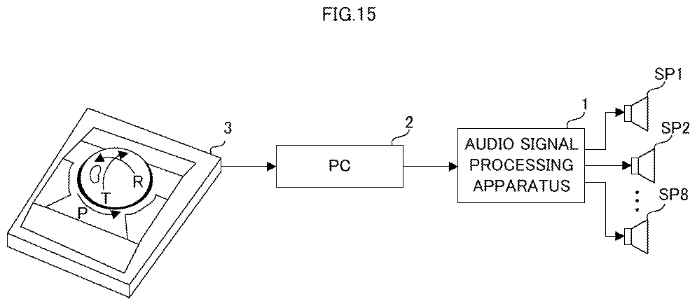

The above-described embodiment shows an example in which the audio signal processing apparatus 1 connects the trackball 3, receives rotation information or information of orthogonal coordinates, and controls the position of a sound source. However, for example, as shown in FIG. 15, a personal computer (hereinafter referred to as a PC) 2 may connect the trackball 3, may receive rotation information or information of orthogonal coordinates, and may control the position of a sound source.

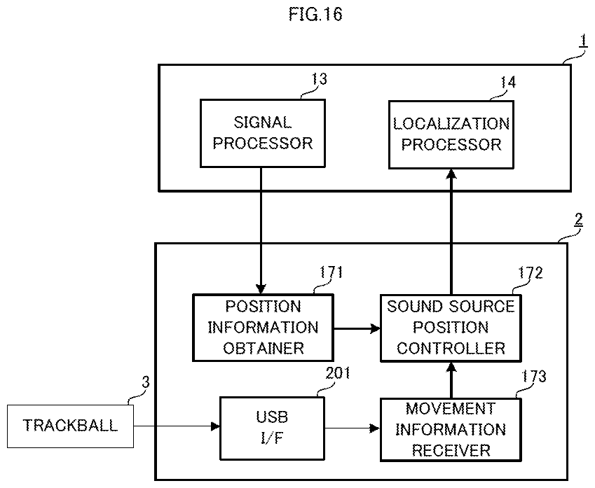

In such a case, the PC 2, as shown in FIG. 16, includes the position information obtainer 171, the sound source position controller 172, and the movement information receiver 173, when a CPU of the PC 2 reads a program. The trackball 3 and the PC 2 are connected, for example, through a USB interface (I/F) 201. In addition, the PC 2 and the audio signal processing apparatus 1 are also connected to a USB interface (not shown). As a matter of course, such connection modes may be an interface of HDMI (registered trademark), a network interface, or the like.

The position information obtainer 171 obtains the position information of the sound source generated by the signal processor 13, from the signal processor 13 of the audio signal processing apparatus 1. Alternatively, the position information obtainer 171 obtains the position information included in the object information decoded by the decoder 12.

The movement information receiver 173 receives rotation information from the trackball 3 through the USB I/F 201. The sound source position controller 172 obtains the position information of the sound source from the position information obtainer 171. In addition, the sound source position controller 172 receives the rotation information from the movement information receiver 173. The sound source position controller 172 rotates the position of the sound source about a predetermined axis, based on the rotation information. The sound source position controller 172 sends the position information after rotation, to the audio signal processing apparatus 1. As a result, the PC 2 changes the sound image localization position of the sound source in the localization processor 14.

As described above, a user can also rotate the position of a sound source by using the PC 2. It is to be noted that, although the position information may be individually sent for each sound source from the PC 2 to the audio signal processing apparatus 1, the position information with respect to all the sound sources may be sent collectively.

It is to be noted that a mouse normally has a resolution of 1600 dpi or the like. The mouse is able to output a value of 160000 samples with respect to the amount of movement of 10 inches, for example. On the other hand, the position information of a sound source may have a relatively low resolution as indicated by a value of −1.000 to +1.000 with respect to the same amount of movement of 10 inches, for example. Then, the sound source position controller 172, in a case in which the resolution of the information received from the trackball 3 is different from the resolution of the position information of a sound source, converts a value of high-resolution information received from the trackball 3 into the value of low resolution of the position information. It is to be noted that the sound source position controller 172 may preferably store the high-resolution information (the information received from the trackball 3) in the flash memory 18 or the RAM 19. In such a case, the sound source position controller 172, when receiving rotation information from the trackball 3 next, updates the rotation information stored in the flash memory 18 or the RAM 19 instead of the position information obtained by the position information obtainer 171 and converts the rotation information into the value of resolution of the position information. As a result, the sound source position controller 172 is able to update the position information, using highly accurate information. However, the sound source position controller 172, when the PC 2 is started first, may obtain current sound source position information from the audio signal processing apparatus 1 through the position information obtainer 171, and may obtain the first reference position.

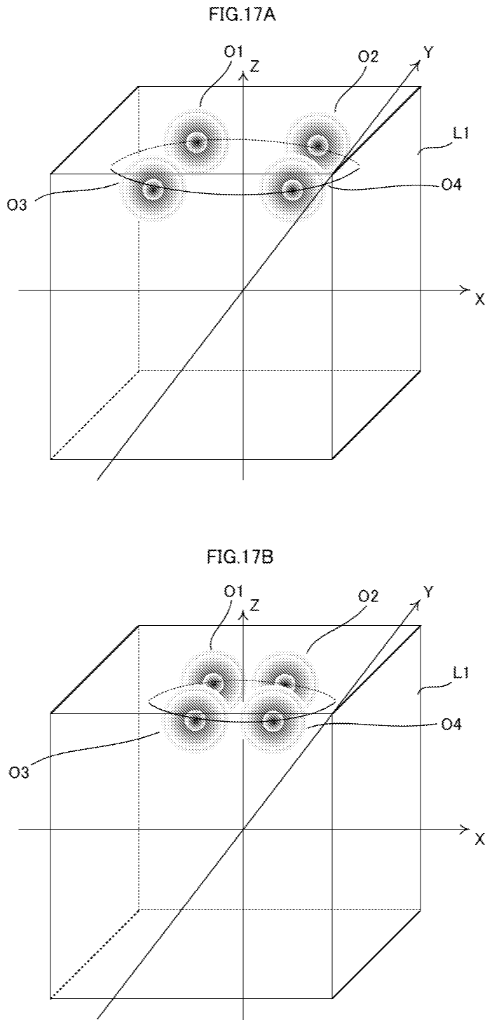

The above-described embodiment shows a mode to rotate the position of a sound source according to a rotation operation from a user. However, the audio signal processing apparatus 1, as shown in FIG. 17A and FIG. 17B, for example, may change the size of the radius of the spherical surface S1 so as to bring the position of a sound source closer to the center according to a rotation operation from a user. Alternatively, the audio signal processing apparatus 1 may bring the position of a sound source closer to an origin point (0, 0, 0) according to a rotation operation from a user.

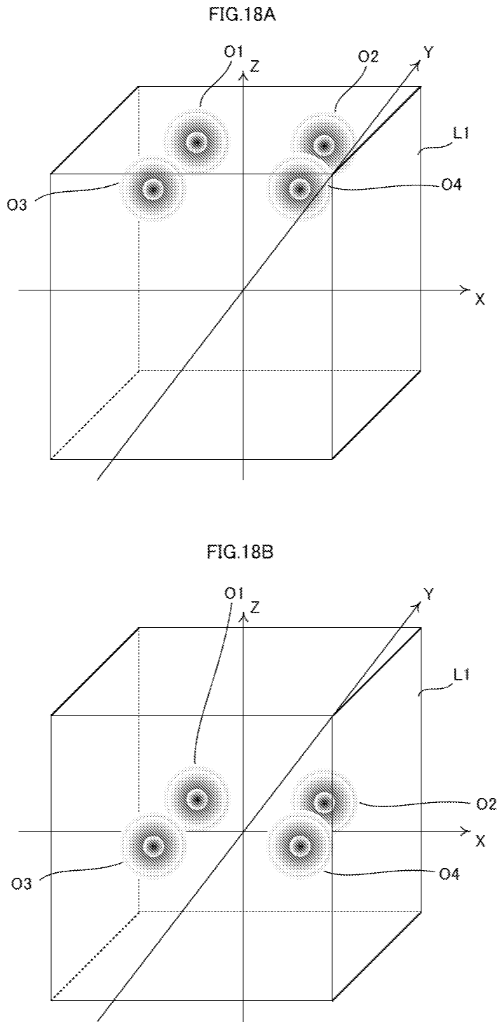

In addition, the audio signal processing apparatus 1, as shown in FIG. 18A and FIG. 18B, may move the position of a sound source up and down according to a rotation operation from a user. In addition, the audio signal processing apparatus 1 may move the position of a sound source left and right or front and rear according to a rotation operation from a user.

In addition, the user, by operating a mode changeover switch (not shown), for example, can select a mode to rotate the sound source, a mode to change the radius of the spherical surface S1, or a mode to move the sound source up and down, left and right, or front and rear, with respect to the rotation operation.

Moreover, an operation from a user is not limited to a rotation operation. For example, the audio signal processing apparatus 1 may receive an operation on a random switch (not shown). In such a case, the audio signal processing apparatus 1 rearranges each sound source at a random position according to the operation on the random switch.

In addition, for example, the audio signal processing apparatus 1 may receive an operation on a straight-line mode switch (not shown). In such a case, the audio signal processing apparatus 1 rearranges each sound source on one straight line according to the operation on the straight-line mode switch.

In addition, for example, the audio signal processing apparatus 1 may receive an operation on a corner arrangement switch (not shown). In such a case, the audio signal processing apparatus 1 rearranges each sound source at a corner (including four corners of a ceiling and the four corners of a floor, for example) of the room L1 according to the operation on the corner arrangement switch.

It is to be noted that the audio signal processing apparatus 1 may associate position information of the current sound source with a specific switch, and may store association in the flash memory 18 or the RAM 19. For example, when a user operates a store button (not shown), the audio signal processing apparatus 1 associates position information of the current sound source with a specific switch, and stores association in the flash memory 18 or the RAM 19. Then, when the user presses a recall button (not shown), position information corresponding to the position information stored in the flash memory 18 or the RAM 19 is read to rearrange the sound source. As a result, the user, by only pressing the recall button, can easily reproduce the past arrangement of the sound source.

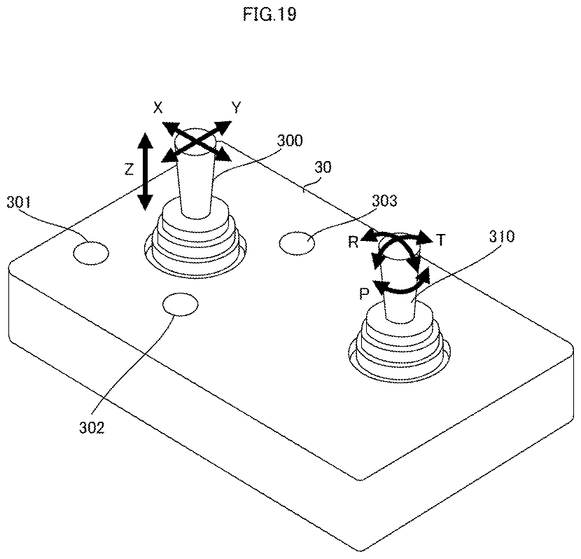

As described above, a movement operation from a user is not limited to a rotation operation. The movement operation also includes a parallel movement operation, for example, in addition to a rotation operation. FIG. 19 is a perspective view showing a modification of an operation reception device. The operation reception device 30, on the top of the housing having a rectangular parallelepiped shape, includes a first stick 300, a second stick 310, a push-button switch 301, a push-button switch 302, and a push-button switch 303.

The first stick 300 is a physical controller that receives a parallel movement operation. The first stick 300 receives left and right parallel movement, and outputs information of an X coordinate as movement information. The first stick 300 receives front and rear parallel movement, and outputs information of a Y coordinate as movement information. In addition, the first stick 300 receives up and down parallel movement, and outputs information of a Z coordinate as movement information.

The sound source position controller 172 moves the position of a sound source according to the movement information of the X, Y, and Z that have been outputted from the operation reception device 30. As a result, a user, by operating the first stick 300, as shown in FIG. 18A and FIG. 18B, can move the sound source up and down, left and right, and front and rear.

The second stick 310 is a physical controller that receives a rotation operation. The second stick 310 receives a left and right tilt operation, and outputs roll (R) information. The second stick 310 receives a front and rear tilt operation, and outputs tilt (T) information. In addition, the second stick 310 receives a rotation operation about the Z axis in a plan view, and outputs pitch (P) information.

In such a case, a user, by operating the second stick 310, as shown in FIG. 6 and FIG. 7, can rotate the position of a sound source.

The user can switch a state of receiving a parallel movement operation, a state of receiving a rotation operation, and a state of receiving an enlargement-reduction operation, by pressing either push-button switch 301, push-button switch 302 or push-button switch 303.

The movement information receiver 173, when receiving pressing information of the push-button switch 301, as shown in FIG. 17A and FIG. 17B, switches to a state of changing the size of the radius of the spherical surface S1 according to the movement information. In such a case, the movement information receiver 173 receives up and down parallel movement, and outputs the information to change the size of the radius of the spherical surface S1, to the sound source position controller 172. When a user moves the first stick 300 in parallel in a vertical direction, the movement information receiver 173 changes the information of the radius of the spherical surface S1 on which the sound source is arranged, according to the numerical value of the Z coordinate that is outputted from the operation reception device 30. It is to be noted that, in a state of changing the size of the radius of the spherical surface S1, the movement information receiver 173 may not receive other operations.

It is to be noted that the operation of receiving the enlargement-reduction of the radius of the spherical surface S1 is not limited to an operation in the vertical direction. For example, the movement information receiver 173 may output the information of the radius of the spherical surface S1, according to the pitch (P) information being the rotation operation about the Z axis with respect to the second stick 310.

On the other hand, when the user presses the push-button switch 302, the movement information receiver 173 is switched to a state of receiving parallel movement. In addition, when the user presses the push-button switch 303, the movement information receiver 173 is switched to a state of receiving rotation movement.

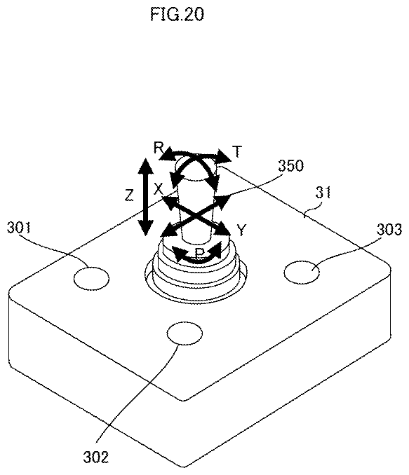

It is to be noted that the physical controller to receive parallel movement, rotation movement, and enlargement-reduction of the radius of the spherical surface S1, as shown in FIG. 20, may be a single physical controller. FIG. 20 is a perspective view showing an operation reception device 31. The operation reception device 31, on the top of the housing having a rectangular parallelepiped shape, includes a third stick 350, a push-button switch 301, a push-button switch 302, and a push-button switch 303.

The third stick 350 is a physical controller that receives both a parallel movement operation (X, Y, Z) and a rotation operation (R, T, P). As with the operation reception device 30, the movement information receiver 173, when receiving the operation on the push-button switch 301, as shown in FIG. 17A and FIG. 17B, is switched to the state of changing the size of the radius of the spherical surface S1. The movement information receiver 173, when receiving the operation on the push-button switch 302, is switched to the state of receiving parallel movement. In addition, the movement information receiver 173, when receiving the operation on the push-button switch 303, is switched to the state of receiving rotation movement.

However, the movement information receiver 173 may receive both the parallel movement and the rotation movement. In such a case, the user can also rotate and move the position of the sound source, while moving the position of the sound source in parallel.

The first stick 300, the second stick 310, and the third stick 350 include a not-shown elastic member inside. The first stick 300, the second stick 310, and the third stick 350, by elastic force of the elastic member, return to the position of the origin point when not being operated.

The movement information receiver 173 changes the position of a sound source by one of the following modes, according to the amount of movement of the first stick 300, the second stick 310, or the third stick 350.

### (Absolute Value Mode)

The absolute value mode corresponds to a first mode. The absolute value mode is a mode to associate the position of the first stick 300, the second stick 310, or the third stick 350 (hereinafter, the stick is referred to as a stick controller) with the position of a sound source on a one-to-one basis.

The sound source position controller 172 and the movement information receiver 173, in a case of receiving an absolute value mode specification operation (such as a long press operation of the push-button switch 301, for example) from a user, store the current position of the sound source as a reference position in the RAM 19. As a result, the movement information receiver 173 associates the current position of the sound source with a position of an origin point of a stick controller. Then, the sound source position controller 172 changes the position of the sound source according to the amount of movement of the stick controller. For example, in a case in which the movement information receiver 173 receives a rotation operation to rotate 90 degrees clockwise about the Z axis, the sound source position controller 172 rotates the position of the sound source 90 degrees clockwise. The sound source position controller 172, when the position of the stick controller returns to the origin point, returns the position of the sound source to the reference position. In addition, for example, in a case in which the movement information receiver 173 receives a rotation operation to rotate 90 degrees clockwise about the Z axis, the sound source position controller 172 may rotate the position of the sound source 180 degrees clockwise. In other words, the sound source position controller 172 may change a ratio of the amount of rotation with respect to the rotation operation.

### (Relative Value Mode)

A relative value mode is a modification of the first mode. The relative value mode is a mode to change the position of a sound source according to the amount of movement from the origin point of a stick controller, and to hold a changed position. The sound source position controller 172 and the movement information receiver 173, in a case of receiving a relative value mode specification operation (such as a long press operation of the push-button switch 302, for example) from a user, shift to the relative value mode. The sound source position controller 172 changes, while performing integration, the position of a sound source, according to the amount of movement from the position of the origin point of the stick controller. For example, in a case in which the movement information receiver 173 receives a rotation operation to rotate 90 degrees clockwise about the Z axis, the sound source position controller 172 rotates the position of the sound source 90 degrees clockwise. In addition, the sound source position controller 172, by the integration, rotates the position of the sound source 270 degrees clockwise, when a user holds a stick controller for 3 seconds at a position at which the user rotates the stick controller 90 degrees, for example. The sound source position controller 172, even when the position of the stick controller returns to the origin point, holds the position of the sound source as it is. It is to be noted that, in this example, in order to simplify the description, the sound source position controller 172, when the stick controller is rotated 90 degrees and held for 3 seconds, rotates the position of the sound source 270 degrees. However, the sound source position controller 172, since also integrating the amount of movement even while the stick controller rotates 90 degrees, actually rotates the position of the sound source 270 degrees or more.

### (Automatic Continuation Mode)

An automatic continuation mode corresponds to a second mode. The automatic continuation mode is a mode to continue a position of a sound source that has been moved according to movement of a stick controller. In the automatic continuation mode, a movement speed of the sound source is changed according to the amount of movement from the origin point of the stick controller.

The sound source position controller 172 and the movement information receiver 173, in a case of receiving an automatic continuation mode specification operation (such as a long press operation of the push-button switch 303, for example) from a user, shift to the automatic continuation mode. The sound source position controller 172 changes the position of the sound source according to the movement of the stick controller. For example, in a case in which the movement information receiver 173 receives an operation of rotating clockwise about the Z axis, the sound source position controller 172 rotates the position of the sound source clockwise. The sound source position controller 172, even when the position of the stick controller returns to the origin point, continues rotating the sound source clockwise.

In addition, the sound source position controller 172 changes the movement speed of the sound source according to the amount of movement from the origin point of the stick controller. For example, the sound source position controller 172 changes a rotational speed of the sound source, depending on a case of receiving a rotation operation to rotate 45 degrees clockwise about the Z axis and a case of receiving a rotation operation to rotate 90 degrees clockwise about the Z axis. For example, the sound source position controller 172, in the case of receiving a 90-degree clockwise rotation operation, rotates at twice the speed in the case of receiving the rotation operation to rotate 45 degrees clockwise about the Z axis.

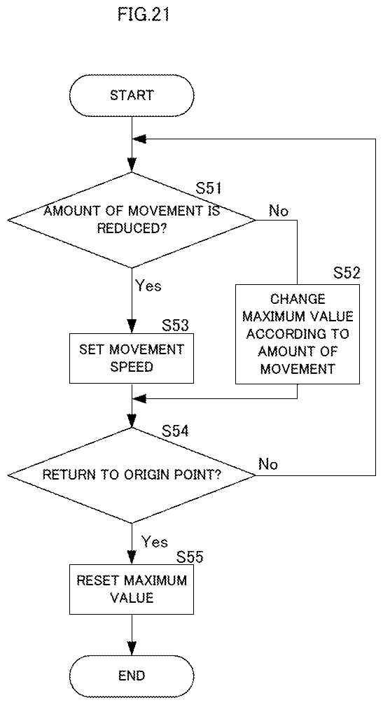

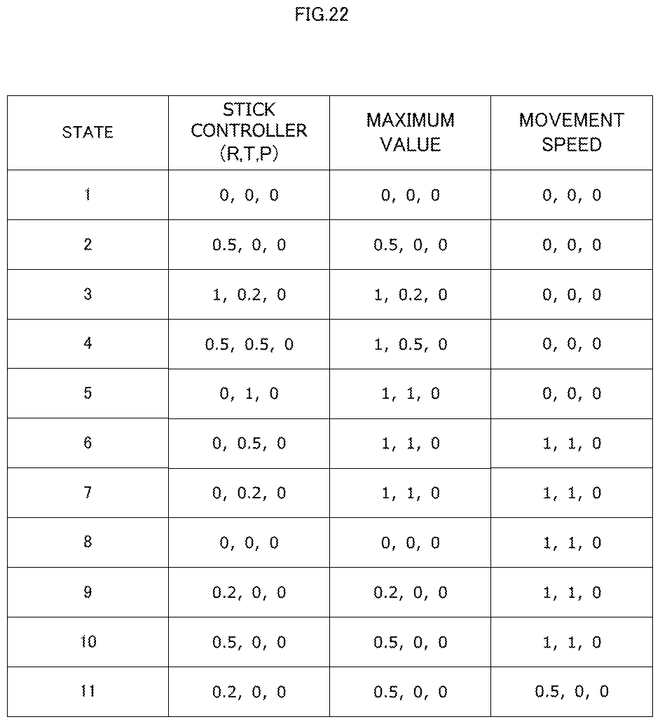

The sound source position controller 172 stores the maximum value of the movement speed in the RAM 19. The sound source position controller 172 manages the movement speed of the sound source according to the maximum value. FIG. 21 is a flow chart showing an operation of a sound source position controller 172 in the automatic continuation mode. FIG. 22 is a view showing a relationship between an amount of movement of the stick controller and the maximum value. It is to be noted that the maximum value means the maximum movement speed from a time when a value stored in the RAM 19 is reset, to the current time.

When the stick controller moves, the sound source position controller 172 starts an operation shown in FIG. 21. The sound source position controller 172 determines whether or not the amount of movement is reduced from the origin point of the stick controller (S51). When the amount of movement is not reduced from the origin point of the stick controller, the sound source position controller 172 updates the maximum value with the amount of movement from the origin point of the stick controller (S52). For example, the amount of movement of the roll (R) from the origin point of the stick controller is increased from State to State 3 shown in FIG. 22. In addition, the amount of movement of the tilt (T) from the origin point of the stick controller is increased from State 3 to State 5. Accordingly, the sound source position controller 172 updates the maximum value with the amount of movement from the origin point of the stick controller from State 1 to State 5 in the example of FIG. 22.

When the amount of movement is reduced from the origin point of the stick controller, the sound source position controller 172 sets the movement speed of the sound source to the maximum value (S53). In other words, in this example, when the amount of movement is reduced from the origin point of the stick controller, the movement speed of the sound source is set as the maximum value. In the example of FIG. 22, since the amount of movement of tilt (T) is also reduced at a time of State 6, the sound source position controller 172 sets the maximum value (1, 1, 0) as the movement speed.

Subsequently, the sound source position controller 172 determines whether or not the position of the stick controller has returned to the origin point (S54). When the position of the stick controller does not return to the origin point, the sound source position controller 172 repeats processing from the determination of S51. In a case in which the position of the stick controller returns to the origin point, the sound source position controller 172 resets the maximum value (S55).

In the example of FIG. 22, the sound source position controller 172 resets the maximum value at a time of State 8. The movement of the sound source continues also in this state. However, in a case in which the stick controller moves next and the amount of movement is reduced, the maximum value is updated. In the example of FIG. 22, the stick controller moves again in State 9, and the amount of movement is reduced in State 11. Accordingly, the sound source position controller 172 changes the movement speed from (1, 1, 0) to (0.5, 0, 0) at a time of State 11.

As a result, a user, in a case of desiring to further increase the current movement speed, may return the stick controller to the origin point, and then simply move the stick controller greatly, and, in a case of desiring to reduce the current movement speed, may return the stick controller to the origin point, and then simply move the stick controller slightly.

It is to be noted that the sound source position controller 172, in the automatic continuation mode, in a case of receiving a movement stop operation (such as a twice press operation of the push-button switch 301, for example) from a user, may stop the movement of the sound source.

It is to be noted that the stick controller may detect pressing force instead of the amount of movement. In such a case, the operation reception device 30 and the operation reception device 31 output movement information according to pressing force. In addition, the shape of the physical controller of the operation reception device is not limited to the shape of a stick. The physical controller may have any shape as long as the physical controller receives a parallel movement operation or a rotation movement operation from a user.

It is to be noted that both the operation reception device 30 and the operation reception device 31 are able to be used simultaneously. For example, a plurality of operation reception devices 31 may be enabled to change positions of respective different sound sources.

The foregoing embodiments are illustrative in all points and should not be construed to limit the present disclosure. The scope of the present disclosure is defined not by the foregoing embodiments but by the scope of claims of patent. Further, the scope of the present disclosure is intended to include all modifications within the scopes of the claims of patent and within the meanings and scopes of equivalents.

For example, in the above-described embodiment, the audio signal processing apparatus 1 localizes the sound image of a sound source in three dimensions by using a plurality of speakers arranged in three dimensions in the room. However, the audio signal processing apparatus 1, for example, may localize the sound image of a sound source in three dimensions with two speakers, headphones, earphones, or the like, by using virtual sound image localization processing such as a head-related transfer function. In addition, the audio signal processing apparatus 1, by outputting beam-like sound and reflecting the sound on a wall or a ceiling, may localize the sound image of a sound source in three dimensions with only a speaker arranged in two dimensions.

What is claimed is:

1. A method of processing an audio signal, the method comprising:
inputting an audio signal;
obtaining position information of a sound source of the audio signal;
receiving of the input of movement information;
moving a position of the sound source around a predetermined axis, based on the movement information;
changing a sound image localization position of the sound source; and
performing localization processing on the audio signal so as to localize a sound image of the sound source at a changed sound image localization position.

2. The method according to claim 1, wherein:
the receiving an input of movement information includes receiving an input of three-dimensional movement information; and
the changing of the sound image localization position includes moving the position of the sound source, based on the three-dimensional movement information.

3. The method according to claim 2, wherein:
the movement information includes rotation information; and
the changing of the sound image localization position includes rotating the position of the sound source, based on the rotation information.

4. The method according to claim 3, further comprising arranging the position of the sound source on a predetermined spherical surface and rotating the position of the sound source along the spherical surface.

5. The method according to claim 1, further comprising moving positions of a plurality of sound sources and changing sound image localization positions of the plurality of sound sources.

6. The method according to claim 1, further comprising:
receiving a specified input to specify a sound source to be moved, among a plurality of sound sources; and
moving the sound source to be moved and changing the sound image localization position of the sound source to be moved, based on the specified input.

7. The method according to claim 1, further comprising displaying the position of the sound source on a display.

8. The method according to claim 1, wherein the changing of the sound image localization position of the sound source, in a case in which resolution of the movement information is different from resolution of the position information, includes converting a value of the movement information into the resolution of the position information.

9. The method according to claim 1, wherein the changing of the sound image localization position of the sound source includes converting the movement information into orthogonal coordinates.

10. The method according to claim 1, wherein the changing of the sound image localization position of the sound source includes moving the position of the sound source, based on the movement information, and then executing a first mode to stop movement of the sound source.

11. The method according to claim 1, wherein the changing of the sound image localization position of the sound source includes moving the position of the sound source, based on the movement information, and then executing a second mode to continue movement of the sound source.

12. The method according to claim 11, wherein the second mode includes:
controlling movement speed of the position of the sound source, based on a maximum value of the movement information; and
resetting the maximum value when the movement information matches a predetermined value.

13. The method according to claim 1, further comprising receiving a movement operation from a user by an operation reception device and inputting the movement information corresponding to the movement operation.

14. The method according to claim 13, wherein the operation reception device includes a trackball.

15. An audio signal processing apparatus comprising:
an audio signal inputter that inputs an audio signal;
a position information obtainer that obtains position information of a sound source of the audio signal;
a movement information receiver that receives an input of movement information;
a sound source position controller that moves a position of the sound source around a predetermined axis, based on the movement information, and changes a sound image localization position of the sound source; and
a localization processor that performs localization processing on the audio signal so as to localize a sound image of the sound source at the sound image localization position that has been changed by the sound source position controller.

16. The audio signal processing apparatus according to claim 15, wherein:
the movement information receiver receives an input of three-dimensional movement information; and
the sound source position controller moves the position of the sound source, based on the three-dimensional movement information.

17. The audio signal processing apparatus according to claim 16, wherein:
the movement information includes rotation information; and
the sound source position controller rotates the position of the sound source, based on the rotation information.

18. The audio signal processing apparatus according to claim 17, wherein the sound source position controller arranges the position of the sound source on a predetermined spherical surface and rotates the position of the sound source along the spherical surface.

19. The audio signal processing apparatus according to claim 15, wherein the sound source position controller moves positions of a plurality of sound sources and changes sound image localization positions of the plurality of sound sources.

20. The audio signal processing apparatus according to claim 15, wherein:
the movement information receiver receives a specified input to specify a sound source to be moved, among a plurality of sound sources; and
the sound source position controller, based on the specified input, moves the sound source to be moved, and changes the sound image localization position of the sound source to be moved.
